(19) United States
(12) Patent Application Publication
(10) Pub. No.: US 2003/0208554 A1
(43) Pub. Date: Nov. 6, 2003

(54) Wireless network access point with computing capability and method of operation thereof

(76) Inventor: Helen A. Holder, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/138,453

(22) Filed: May 3, 2002

(51) Int. Cl. G06F 15/16

(52) U.S. Cl. 709/217; 709/229

(57) ABSTRACT

A method of distributing information to at least one client, may include the steps of receiving an information request at a gateway from at least one client, wherein the gateway may include both wired and wireless capability and wherein the gateway is capable of local processing; determining whether the information is available locally; transferring the information to the at least one client if the information is available locally; and redirecting the request to a server if the information is not available locally.

### RELATED APPLICATIONS

The present application is related to commonly assigned U.S. patent application Ser. No. ______ [Attorney Docket No. 100200218-1] entitled “WIRELESS DONGLE WITH COMPUTING CAPABILITY FOR EQUIPMENT CONTROL AND METHOD OF OPERATION THEREOF,” and U.S. patent application Ser. No. ______ [Attorney Docket No. 100200217-1] entitled “SEMICONDUCTOR AUTOMATION MARKUP LANGUAGE BASED GEM/SEC DEVELOPMENT APPLICATION,” filed on the same date herewith, the disclosures of which are hereby incorporated by reference in their entireties.

### FIELD OF THE INVENTION

This invention relates generally to Local Area Networks and, more particularly, to access points with computing capability.

### BACKGROUND OF THE INVENTION

High speed connections, such as Digital Subscriber Lines (DSL) and cable modems, are quickly replacing conventional 56 kilobit-per-second dial-up connections to the Internet. Now, users can enjoy up to ten times faster download speeds by using a high speed connection rather than by using traditional dial-up Internet connections. The high speed connections allow businesses with more than one networked device to connect to the Internet with little or no slowdown of information transfer. To enable Internet access sharing among devices, business and home users are using a combination of both hardware and software solutions that distribute and/or share a high speed connection among multiple devices.

A Local Area Network (LAN) may be used to interconnect devices or nodes such as personal computers, laptops, handheld devices and server platforms. Each node in a LAN has its own Central Processing Unit (CPU) that performs various processing tasks. The CPU also enables the node to access data and devices anywhere on the LAN. For example, users may use the LAN to communicate with each other by sending e-mail or engaging in chat sessions. Multiple client nodes may share content located on a file server node, exchange e-mail through a mail server or communicate directly on a peer-to-peer basis.

In addition to client and server nodes, an access point node, such as a router or gateway, may be integrated into the LAN. The access point node enables the nodes to communicate with remote nodes such as a web server located outside the LAN. The access point node uses message headers and a forwarding table to determine where a received packet should go, and Internet Control Messaging Protocol (ICMP) to communicate with other routers and determine the best route between any two nodes. Access point nodes are able to communicate with nodes in a fixed networked environment, such as a wired environment having Category 5 cabling, or in a wireless networked environment, for example, using high-frequency radio waves that comply with the IEEE 802.11 wireless local area network or Bluetooth protocols rather than wires to communicate with nodes.

An access point node may interconnect wireless clients and servers and connect the clients and servers to the Internet. In conventional settings, a web browser resides within wired or wireless clients and is used to access specially formatted “web pages” that reside on a remote web server. The clients and the web server may communicate using a conventional protocol such as “HyperText Transfer Protocol” (HTTP). In one configuration, a browser located within a client opens a connection to a remote web server (also called a website) and initiates a request for a document. The server delivers the requested document, typically in a standard coded format such as the “HyperText Markup Language” (HTML) format. After the document is delivered, the connection is closed. The browser renders the document, displaying content or performing a function designated by the document.

A cache server may be an intermediate server between clients and web servers. The cache server intercepts traffic from local clients initiating client requests for web pages, images and files (collectively, called objects). Each object transmitted from the remote web server may be copied and stored locally by the cache server. If there is another request for the same object, the cache server may provide a copy of the object to the requesting client, instead of requiring the remote web server to resend the same object. By using the cache server, latency is reduced since the request is satisfied from the cache server, which is closer to the client and avoids congestion and delays on the Internet, instead of from the remote web server. Ultimately, this makes websites more responsive.

A router with wireless communication capability may act as an access point and may be connected to the cache server and the clients. For example, a wireless gateway available from the Hewlett Packard (HP) Company allows wireless clients to roam freely and yet still connect to other nodes on a LAN and to external nodes via a high speed connection. A wireless card, such as the wireless LAN card available from HP, resides in the wireless client to enable the wireless client to transmit information to the access point.

### SUMMARY OF THE INVENTION

A method of distributing information to at least one client, may include the steps of receiving an information request at a gateway from at least one client, wherein the gateway may include both wired and wireless capability and wherein the gateway may be capable of local processing, determining whether the information is available locally, transferring the information to the at least one client if the information is available locally, and redirecting the request to a server if the information is not available locally.

### BRIEF DESCRIPTION OF THE DRAWINGS

FIG. 1 is a block diagram of a Local Area Network according to an embodiment of the invention;

FIG. 2 is a block diagram of the smart gateway according to an embodiment of the invention as depicted in FIG. 1;

FIG. 3 is flow chart of the steps performed when processing packets according to an embodiment of the present invention; and

FIG. 4 is a flow chart of the steps performed when communicating with distributing devices according to an embodiment of the present invention.

### DETAILED DESCRIPTION

Methods, systems, and articles of manufacture consistent with the present invention may overcome shortcomings of existing network access point systems by providing a smart gateway with embedded computing capability and intelligence. Specifically the smart gateway may contain computing capability to locally process and provide information, such as applications, software or other information, without the use of an intermediate server. The smart gateway may include intelligence that enables nodes to communicate effectively and efficiently with remote nodes since the smart gateway examines incoming and outgoing packets to ensure proper destination. The smart gateway may also provide a user with complete access to all functionality of its operating system. The smart gateway may be small and efficient, housed in a small footprint casing. The smart gateway is capable of interconnecting various types of nodes and managing communication between local notes and remote nodes in external networks, such as web servers. The smart gateway may connect nodes by either wired or wireless connections.

In one embodiment, access points with wireless capability have a limited microprocessor and basic logic to route packets and run wireless access point protocols. These access points route packets without applying intelligence to the packets. A smart gateway may use intelligence by monitoring packets and evaluating packet content. Such smart gateways not only provide multiple applications to multiple nodes, but also integrate and supports existing LANs while providing additional computing capability and functionality.

A smart gateway provides a number of benefits over traditional access points. The smart gateway may be capable of processing information locally and handling a multitude of client requests and serving applications to multiple clients since the smart gateway contain additional computing capability. Additionally, the smart gateway reduces latency since the smart gateway handles client requests without necessarily having to communicate with remote servers. Instead, the smart gateway maintains a local copy of objects frequently and/or most recently requested by nodes. Further, the smart gateway may intelligently and directly communicate with distributed devices, such as sensors or other handheld devices, without relying on client software or client requests to forward objects to the distributed devices. So as to support the additional functionality, the smart gateway contains computing capability and software to enable such communication sessions.

FIG. 1 illustrates network 100 suitable for use with methods and systems consistent with an embodiment of the present invention. Network 100 may include a number of devices, such as fixed clients 101, wireless clients 102 and distributed sensors 103, all electronically connected to smart gateway 104 via wireless or wireline links. Clients 101 may be personal computers, such as an HP personal computer, and may communicate with smart gateway 104 using a network card (not shown), such as an ethernet network card, token ring card, or similar cards and/or devices. Wireless clients 102 may be portable personal computers, such as HP laptops, or handheld devices, such as the HP JORNADA handheld and pocket device. Wireless clients 102 may also have a wireless network card, such as PCMCIA card (not shown), to transmit information to and receive information from smart gateway 104. For example, wireless client 102 may use an HP wireless LAN PCMCIA card. In one embodiment, distributed sensors 103 may be electronic sensors, such as thermometers, barometers, or any other electronic device. Smart gateway 104 may connect client 101, wireless client 102 and distributed sensors 103 to a public network, such as the Internet 106, and thereby to other networks or devices, such as web server 105.

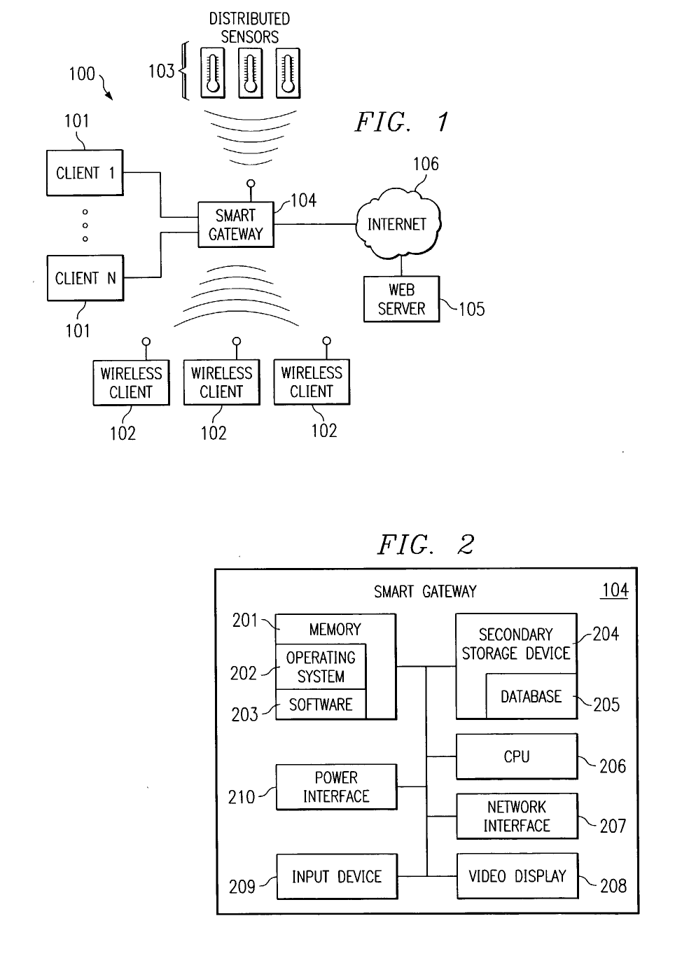

FIG. 2 is a more detailed view of smart gateway 104, which may include memory 201, secondary storage device 204, Central Processing Unit (CPU) 206, network interface 207, video display 208, input device 209 and power interface 210. Memory 201 has stored therein operating system 202 and software 203. Operating system 202 may provide applications to clients 101, 102 (FIG. 1). An example of an operating system that is suitable for use with an embodiment of the present invention is Nanux® (a small version of Linux available at http://www.nanux.com) or WINDOWS CE®, available from MICROSOFT®. A user may access all functionality of operating system 202. Software 203 may control and configure smart gateway 104 and may transmit and receive information from clients 101, 102 and sensors 103 (FIG. 1) in connection with operating system 202. An example of software suitable for use with an embodiment of the present invention may be a web server, such as the Apache web software available for download from http://www.apache.org and the Squid web proxy cache software available for download from http://www.squid-cache.org.

Software 203 may include software that (i) authenticates and stores preference information, for example, desktop settings or font colors associated with a user (e.g., a personal agent) using client 101, 102, (ii) automatically subscribes a user upon successful authentication, (iii) shares content, such as audio or video content with other users, (iv) controls and maintains information associated with users in a game environment, such as keeping local game status files and update information in a database, (v) enables distributed computing so that each smart gateway may provide processing capability, (vi) monitors sensors and analyzes associated data received from the sensors and (vii) tracks clients and devices in physical space. A personal agent is software that collects personal information about a user and may be used to ensure personal information is available when the associated user accesses the system on an alternate machine.

Secondary storage device 204 may include database 205 including information associated with objects recently requested by clients 101, 102 and information associated with software 203, such as user preferences, game data, measurement data. One will note that information associated with objects may also be placed in a file or a lookup table that may be stored in a high-speed storage mechanism, such as Static Random Access Memory (SRAM). One will note that a Network interface 207 may be a wired network interface or a wireless network interface. Power interface 210 may interface with a variety of power sources, such as A/C power or fuel cell power.

Although aspects of software 203 are described as being stored in memory, the software may be stored on or read from other computer readable media or from secondary storage devices, including, for example, hard disks, floppy disks, and CD-ROM, a carrier wave received from a network like the Internet or other forms of Read Only or Random Access Memory (ROM or RAM). Additionally, although specific components and programs of smart gateway 104 and of servers have been described, note that these may contain additional or different components or programs.

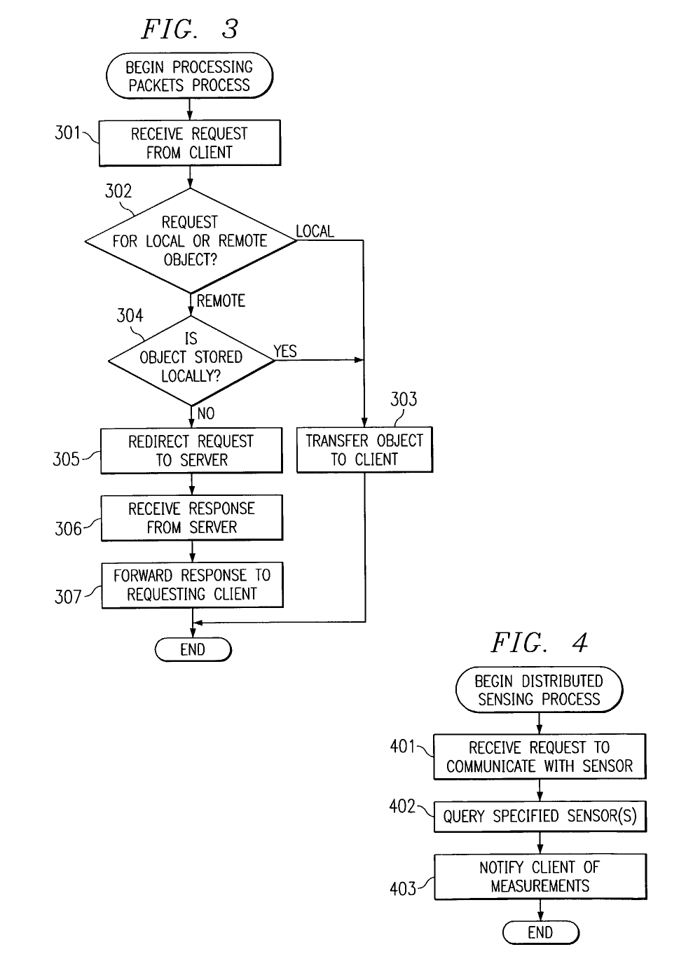

FIG. 3 is a flow chart of packet processing steps performed by a smart gateway according to one embodiment of the invention. Packet processing is initiated, for example, by receiving a request from a client for an object at step 301. The request may be a request for an object located on server 105 (FIG. 1) or an object located in secondary storage device 204 (step 302). For example, the request may be for an object located on server 105, such as a web page or for an object located in secondary storage device 204, such as game environment information, client authentication information, personal preferences or distributed sensor information. If the request is for an object located in secondary storage device 204, smart gateway 104 transfers the local object to the requesting client (step 303). For example, a client may transmit an authorization request to smart gateway 104. The authorization request may include authentication information (e.g., username and password). At step 303, Smart gateway 104 provides access to the client if the authentication information is matched with authentication information stored in database 205.

If, however, smart gateway 104 receives a request for a remote object from a client, it may first determine if a copy of the object is stored locally (step 304). For example, smart gateway 104 may search database 205 to determine if the object has recently been requested by another client. Smart gateway 104 stores a copy of remote objects for a predetermined period of time. If a copy of the object is available locally, smart gateway 104 may transfer the object to the requesting client by way of a wired connection or a wireless connection (step 303). If the object is not available locally, then smart gateway 104 may redirect the received request to web server 105 (FIG. 1) (step 305). For example, smart gateway 104 may be unable to locate the requested object in database 205 if another client has not recently requested the object.

Next, smart gateway 104 receives a response from server 105 (step 306). The response may be the requested object or an indication that the object is unavailable. Once the response is received from server 105, smart gateway 104 may store a copy of the received response (e.g., an object) locally in database 205. Once a copy of the object is stored, each time a client requests the same object, smart gateway 104 may return the copy of the object stored in database 205 instead of redirecting the request to server 105 and, thus reduce latency.

Finally, smart gateway 104 may forward the response from server 105 to the requesting client (step 307). Smart gateway 104 may use intelligence to forward the response to the requesting client. That is, smart gateway 104 may contain software, such as firewall software or other filtering software, to determine which client to transmit the response. System 100 may also authenticate a client before sending requested information. Authentication is used to determine if the client is authorized to receive requested information. Authentication information may be stored in a high-speed storage device for use in verifying a client's authentication information.

FIG. 4 depicts a flow chart of the steps performed by smart gateway 104 when communicating with distributed sensors 103. The distributed sensor communication process is initiated, for example, by receiving a request from a client to communicate with distributed sensor 103 (step 401). For example, the request may be to receive updated measurement information or receive an indication of an error status. Next, smart gateway 104 may query specified distributed sensors 103 (step 402). For example, software 203 may include software to monitor distributed sensors 103 and may request measurement information from one-third of the distributed sensors. Smart gateway 104 may determine if the response is expected by information stored in database 205 (e.g., high temperature or low temperature). If a particular sensor returns a measurement to smart gateway 104 that is not expected, smart gateway 104 may indicate an error condition and alert a user. In addition, smart gateway 104 may transmit a control command to control equipment associated with the distributed sensors. For example, smart gateway 104 may request heating equipment to shut down if the distributed sensors indicate excess temperature. Finally, smart gateway 104 may alert the requesting client of the measurements or the actions taken by smart gateway 104 (step 403).

What is claimed is:

1. A method of distributing information to at least one client, comprising the steps of:
receiving an information request at a gateway from at least one client, wherein the gateway includes both wired and wireless capability and wherein the gateway is capable of local processing;
determining whether the information is available locally;
transferring the information to the at least one client if the information is available locally; and
redirecting the request to a server if the information is not available locally.

2. The method of claim 1 further comprising the steps of:
forwarding requested information to the at least one client after receiving a response from the server, wherein the response includes the information; and
storing a copy of the information in memory located in the gateway for a predetermined period of time.

3. The method of claim 2 wherein the step of forwarding the information to the at least one client further comprises the steps of:
determining which of the at least one clients requested the information by referring to a lookup table in the gateway; and
forwarding the information to each of the requesting clients based on the determination.

4. The method of claim 1 wherein the step of determining whether the information is available locally further comprises the steps of:
determining whether the information request is for remote information or local information;
locating, in a database, information associated with the request;
notifying the requesting client that the information is not available if it is determined that the request is for local information and the information is not located; and
redirecting the request to the server if it is determined that the request is for remote information and the information is not located.

5. The method of claim 1 wherein the step of receiving a request further includes the steps of:
receiving a request for authenticating a client, wherein the request includes authentication information;
determining if the client is authorized based on the authentication information; and
authenticating the client if it is determined that the client is authorized.

6. The method of claim 5 wherein the step of determining if the client is authorized further includes the step of verifying the authentication information with information in a high-speed storage device.

7. The method of claim 1 wherein the step of receiving a request from a client for information further comprises the steps of:
receiving a request from at least one client for personal preferences; and
transferring the requested personal preferences to the at least one client.

8. The method of claim 1 further comprising the steps of:
communicating with a plurality of distributed sensors;
querying the plurality of distributed sensors;
receiving a response, wherein the response indicates the status of a distributed sensor; and
processing the response.

9. The method of claim 8 wherein the step of processing the response includes the step of determining if the response is expected and, if the response is not expected, transmitting the response to the at least one client.

10. The method of claim 9 further including the step of determining if the response is expected and, if the response is not expected, transmitting a control command to equipment associated with the distributed sensors.

11. A gateway with computing capability, the gateway comprising:
a memory for storing instructions capable of being executed by the gateway;
a processor connected to said memory so as to execute the instructions;
a secondary storage device connected to said processor for storing data associated with requests received from clients; and
a network interface for interconnecting a plurality of clients and a network, wherein the network interface is capable of wired and wireless communication with clients.

12. The gateway of claim 11 wherein the memory further stores instructions for serving applications to the plurality of clients.

13. The gateway of claim 13 wherein the memory further stores instructions for:
receiving requests for information from one of the plurality of clients;
determining whether the information is available locally;
distributing the information to the requesting client if the information is available locally; and
redirecting the request to a server if the information is not available locally.

14. The gateway of claim 13 wherein the memory further stores instructions for locating, in the secondary storage device, information associated with the request.

15. The gateway of claim 13 wherein the network interface is a wireless interface.

16. The gateway of claim 11 wherein the memory contains additional instructions for routing packets to a destination based on information contained in a header of said packet.

17. The gateway of claim 11 wherein the memory contains additional instructions for executing an application.

18. The gateway of claim 11 further comprising a wireless communication port for communicating with the distributed sensors, and wherein the memory stores instructions for:
receiving requests for distributed sensor measurements from one of the plurality of clients;
determining which distributed sensors to query;
querying the determined distributed sensor for measurements; and
transmitting the measurements to the requesting client.

19. The gateway of claim 18 wherein the memory further stores instructions for processing the received measurements.
